(19) United States
(12) Patent Application Publication
(10) Pub. No.: US 2015/0014536 A1
(43) Pub. Date: Jan. 15, 2015

(54) ELECTRONIC DEVICE WITH DISTANCE MEASURE FUNCTION AND RELATED METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: XIAN QIAN, Shenzhen (CN)

(21) Appl. No.: 14/325,632

(22) Filed: Jul. 8, 2014

(30) Foreign Application Priority Data
Jul. 10, 2013 (CN) 2013102892583

(51) Int. Cl. G01S 17/10

(52) U.S. Cl. CPC G01S 17/10
USPC 250/338.4

(57) ABSTRACT

A method for measuring a distance between an electronic device and an object is provided. The method includes: starting to emit infrared light to an object when the electronic device is parallel to a length of the object which is perpendicularly placed and is configured to reflect the received infrared light to a photodiode; stop the timer to acquire a period of time when the photodiode receives the reflected-infrared light from the object; calculating a transmission distance of the infrared light during the period of time; and calculating the distance between the electronic device and the object according to a first distance from the infrared light source to the photodiode and the transmission distance of the infrared light source during the period of time.

### CROSS-REFERENCE TO RELATED APPLICATIONS

This application claims priority to Chinese Patent Application No. 201310289258.3 filed on Jul. 10, 2013 in the China Intellectual Property Office, the contents of which are incorporated by reference herein.

### FIELD

The present disclosure relates to electronic devices, and particularly to an electronic device with a distance measure function and a related method.

### BACKGROUND

It is inconvenient for a user to carry a ruler to measure a distance between an electronic device and an object at any time.

### BRIEF DESCRIPTION OF THE DRAWINGS

FIG. 1 illustrates a block diagram of an embodiment of an electronic device.

FIG. 2 is a block diagram of a processor of FIG. 1.

FIG. 3 shows measuring a distance between the electronic device and the object of FIG. 3.

FIG. 4 is a flowchart of a method of measuring distance of the object implemented by the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

Embodiments of the present disclosure will be described with reference to the accompanying drawings.

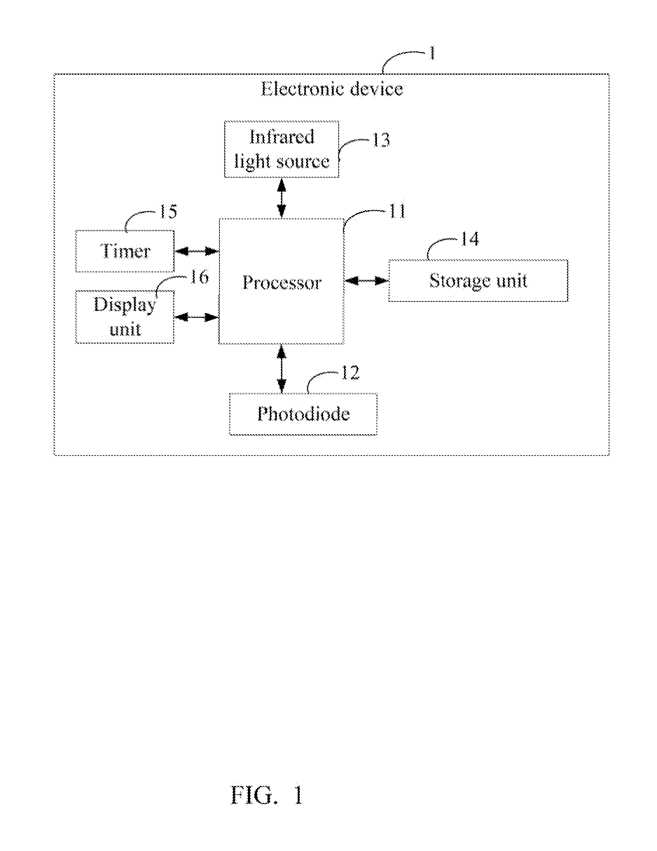

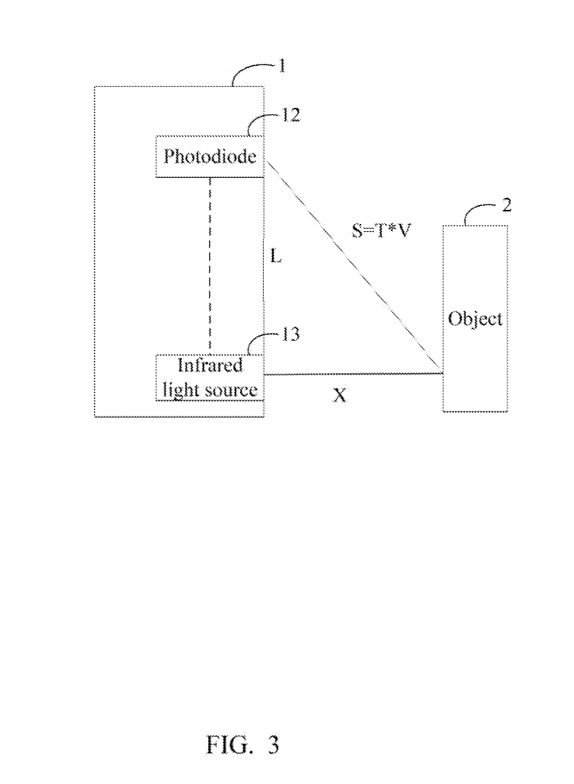

FIG. 1 illustrates an embodiment of an electronic device 1. The electronic device 1 includes a processor 11, a photodiode 12, an infrared light source 13 arranged on a same side with the photodiode 12, a storage unit 14, a timer 15, and a display unit 16. The photodiode 12 receives infrared light. The infrared light source 13 emits infrared light. In one embodiment, the infrared light source 13 is an LED light. The storage unit 14 stores a first distance between the infrared light source 13 and the photodiode 12. As shown in FIG. 3, the first distance is represented as L. The timer 15 records time. The display unit 16 displays information.

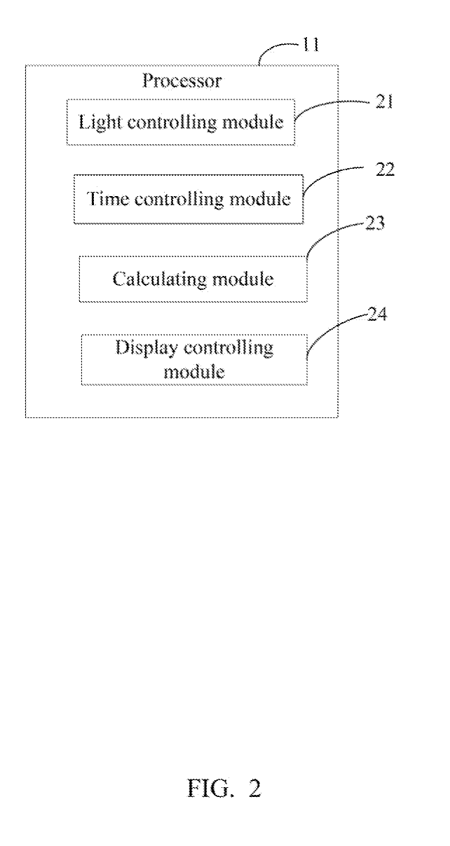

Referring to FIG. 2, the processor 11 includes a light controlling module 21, a time controlling module 22, a calculating module 23, and a display controlling module 24.

The light controlling module 21 controls the infrared light source 13 to emit infrared light to an object 2. In at least one embodiment, the electronic device 1 and the object are rectangular. The object 2 reflects the received infrared light to the photodiode 12. The time controlling module 22 controls the timer 15 to start timing when the infrared light source 13 starts emitting infrared light Herein, the infrared light source 13, the photodiode 12, and an infrared light point on the object 2 forms a right-angled triangle.

The time controlling module 22 controls the timer 15 to stop timing to acquire a period of time when the photodiode 12 receives the reflected-infrared light from the object 2. As shown in FIG. 3, the period of time is represented as T.

The calculating module 23 calculates a transmission distance of the infrared light during the period of time by multiplying a velocity of the light and the period of time. As shown in FIG. 3, the transmission distance of the infrared light during the period of time is represented as S. The transmission distance of the infrared light during the period of time is equal to a sum of a second distance of the infrared light from the infrared light source 13 to the object 2 and a third distance of the infrared light from the object 2 to the photodiode 12. The second distance is equal to the distance between the electronic device 1 and the object 2. As shown in FIG. 3, the second distance of the infrared light from the infrared light source 13 to the object 2 is represented as X. The third distance of the infrared light from the object 2 to the photodiode 12 is represented as S-X.

The calculating module 23 calculates the second distance according to the stored first distance from the infrared light source to the photodiode and the transmission distance of the infrared light source during the period of time. As shown in FIG. 3, the velocity of light is represented as V, according to the Pythagorean theorem, (S−X)*(S−X)=L*L+X*X=(T*V−X)*(T*V−X). Because the parameters T, V and L are known, the parameter X can be determined.

The display controlling module 24 displays the calculated distance between the electronic device 1 and the object 2 on the display unit 16.

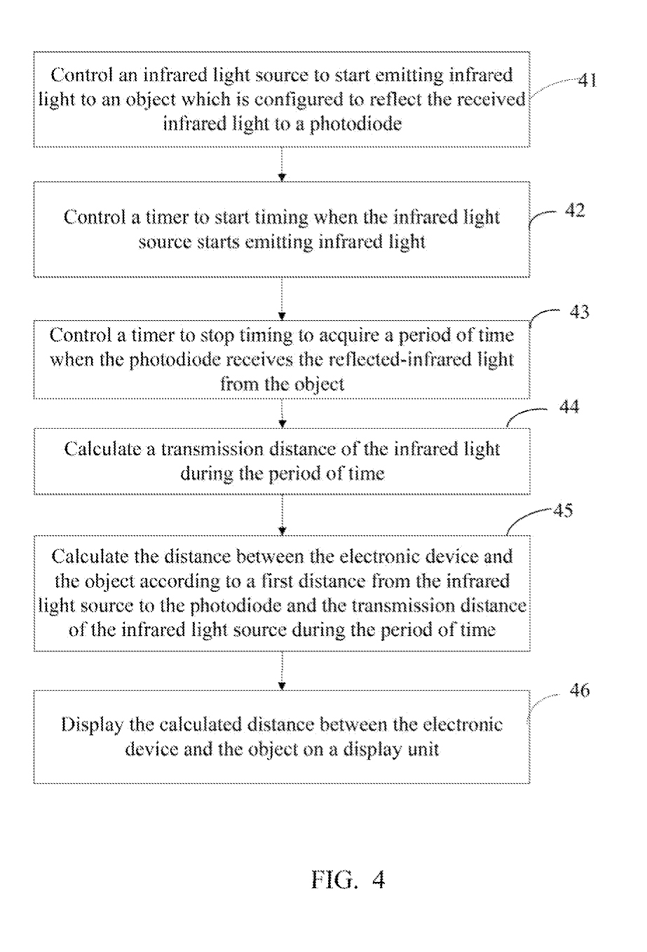

FIG. 4 is a flowchart of a method of measuring distance of an object implemented by the electronic device of FIG. 1.

In block 41, a light controlling module controls an infrared light source to start emitting infrared light to an object.

In block 42, a time controlling module controls a timer to start timing when the infrared light source starts emitting infrared light.

In block 43, the time controlling module controls the timer to stop timing to acquire a period of time when the photodiode receives the infrared light from the object.

In block 44, a calculating module calculates a transmission distance of the infrared light during the period of time by velocity of light multiplying the period of time.

In block 45, the calculating module calculates the second distance according to the stored first distance from the infrared light source to the photodiode and the transmission distance of the infrared light source during the period of time.

In block 46, a display controlling module displays the calculated distance between the electronic device and the object on a display unit.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An electronic device with a distance measurement function comprising:
a processor;
a timer coupled to the processor;
a photodiode coupled to the processor;
an infrared light source coupled to the processor and arranged on a same side of the electronic device as the photodiode;
a storage unit configured to store a first distance between the infrared light source and the photodiode; and
the processor configured to:
control the infrared light source to emit infrared light to an object configured to reflect the received infrared light to the photodiode, wherein the infrared light source, the photodiode, and an infrared light point on the object forms a right-angled triangle;
start the timer when the infrared light source starts to emit the infrared light;
stop when the photodiode receives the reflected-infrared light from the object, the timer and acquire a period of time from the timer;
calculate a transmission distance of the infrared light during the period of time;
calculate the distance between the electronic device and the object according to the stored first distance from the infrared light source to the photodiode and the transmission distance of the infrared light source during the period of time; and
display the distance between the electronic device and the object.

2. The electronic device as described in claim 1, wherein the processor calculates the transmission distance of the infrared light during the period of time by multiplying a velocity of light and the period of time.

3. The electronic device as described in claim 1, wherein the processor calculates the distance between the electronic device and the object according to Pythagorean theorem and the stored first distance and the transmission distance of the infrared light during the period of the time.

4. A method for measuring a distance between an electronic device and an object, the method comprising:
controlling the infrared light source to emit infrared light to an object configured to reflect the received infrared light to the photodiode, wherein the infrared light source, the photodiode, and an infrared light point on the object forms a right-angled triangle;
starting the timer when the infrared light source starts to emit the infrared light;
stopping when the photodiode receives the reflected-infrared light from the object, the timer and acquire a period of time from the timer;
calculating a transmission distance of the infrared light during the period of time;
calculating the distance between the electronic device and the object according to a first distance from the infrared light source to the photodiode and the transmission distance of the infrared light source during the period of time; and
displaying the distance between the electronic device and the object.

5. The method as described in claim 4, further comprising:
calculating the transmission distance of the infrared light during the period of time by multiplying a velocity of light and the period of time.

6. The method as described in claim 4, further comprising:
calculating the distance between the electronic device and the object according to the Pythagorean theorem and the stored first distance and the transmission distance of the infrared light during the period of the time.
